(19) United States
(12) Patent Application Publication
(10) Pub. No.: US 2022/0065509 A1
(43) Pub. Date: Mar. 3, 2022

(54) SELF PIERCING CAN TAPPERS FOR FLUID MANAGEMENT

(71) Applicant: Alltemp Products Company Limited, Pickering (CA)

(72) Inventors: Paul Clarence APPLER, Windsor (CA); Jesse Richard HOMENUIK, Windsor (CA); Norma HILL, Windsor (CA)

(21) Appl. No.: 17/418,325

(22) PCT Filed: Dec. 24, 2019
(86) PCT No.: PCT/CA19/51910

§ 371 Date: Jun. 25, 2021

Related U.S. Application Data
(60) Provisional application No. 62/785,269, filed on Dec. 27, 2018.

(51) Int. Cl. F25B 45/00; F16L 41/04; F16L 55/07; F16L 55/164

(52) U.S. Cl. CPC F25B 45/00; F16L 41/04; F25B 2345/006; F16L 55/164; F25B 2345/001; F16L 55/07

(57) ABSTRACT

A device comprises: a container; a first fitting with a stationary piercing pin coupled to the container; and a second fitting coupled to the container, wherein the first fitting is configured for coupling to and piercing a sealed fluid filled canister and the second fitting is configured for coupling to a service port of the system such that a fluid can travel from the fluid filled canister through the device into the service port of the system, wherein the system comprises at least one of an air conditioning system or a refrigeration system.

### CROSS-REFERENCE TO RELATED PATENT APPLICATIONS

This patent application claims a benefit of U.S. Provisional Patent Application 62/785,269 filed 27 Dec. 2018, which is herein incorporated by reference in its entirety for all purposes.

### TECHNICAL FIELD

Generally, this disclosure generally relates to injection technologies utilized in heating, ventilation, air-conditioning, and refrigeration (HVAC/R) systems. More particularly, this disclosure relates to self piercing apparatuses to facilitate injections of additive compositions in such HVAC/R systems.

### BACKGROUND

In this disclosure, where a document, an act, and/or an item of knowledge is referred to and/or discussed, then such reference and/or discussion is not an admission that the document, the act, and/or the item of knowledge and/or any combination thereof was at a priority date, publicly available, known to a public, part of common general knowledge, and/or otherwise constitutes any prior art under any applicable statutory provisions; and/or is known to be relevant to any attempt to solve any problem with which this disclosure may be concerned with. Further, nothing is disclaimed.

There is a difficulty in introducing a fluid or additive into an HVAC/R system. Accordingly, there is a desire to address this difficulty. Presently, multiple injection methods are employed when delivering additives into HVAC/R systems. These injection methods may or may not require additional tools, however, current available methods require multiple steps and a final manual manipulation of a device to inject additives, such as plunging the depressor on a syringe, attaching refrigerant gauge and cylinder for necessary pressure, manually depressing a push button to open flow, or manually piercing the vessel with a turn style pin.

### SUMMARY

This disclosure may at least partially address at least one of above inefficiencies. However, this disclosure can prove useful to other technical areas. Therefore, various claims recited below should not be construed as necessarily limited to addressing any of the above inefficiencies.

In an embodiment, a device comprises: an injection vessel; a first fitting coupled to a canister; and a second fitting coupled to the HVAC/R system, wherein the first fitting is configured for coupling to an additive filled canister and the second fitting is configured for coupling to a service port of the system such that a fluid can travel from the additive filled canister through the device to the service port while the system is running, wherein the system comprises at least one of an air conditioning system or a refrigeration system.

In an embodiment, a device comprises: an injection vessel; a first fitting coupled to the injection vessel; and a second fitting coupled to the injection vessel, wherein the first fitting is configured for coupling to and piercing a fluid filled canister and the second fitting is configured for coupling to a service port of an HVAC/R system such that a fluid can travel from the vessel through the first fitting to the service port through the injection vessel into the system, wherein the system comprises at least one of an air conditioning system or refrigeration system.

In an embodiment, a device comprises: a container including a first end portion and a second end portion; a first fitting including a stationary pin, wherein the first end portion hosts the first fitting; and a second fitting including a valve that is closed by default, wherein the second end portion hosts the second fitting, wherein the stationary pin is configured to pierce a canister storing a fluid responsive to the first fitting being secured to the canister and the valve is configured to open responsive to the second fitting being secured to a service port of a system such that the fluid is able to travel from the canister to the service port through the first fitting, the container, and the second fitting, wherein the system includes at least one of an air conditioning system or a refrigeration system.

In an embodiment, a method comprises: causing a stationary pin to pierce a canister storing a fluid responsive to a first fitting being secured to the canister, wherein the first fitting includes the stationary pin, wherein the first fitting is secured to a first end portion of a container, wherein the container includes a second end portion hosting a second fitting, wherein the second fitting includes a valve that is closed by default; and causing the valve to open responsive to the second fitting being secured to a service port of a system such that the fluid is able to travel from the canister to the service port through the first fitting, the container, and the second fitting.

This disclosure may be embodied in various forms illustrated in a set of accompanying illustrative drawings. Note that variations are contemplated as being a part of this disclosure, limited only by a scope of various claims recited below.

### DESCRIPTION OF FIGURES

The set of accompanying illustrative drawings shows various example embodiments of this disclosure. Such drawings are not to be construed as necessarily limiting this disclosure. Like numbers and/or similar numbering scheme can refer to like and/or similar elements throughout.

FIG. 1 is a side view of an injection vessel utilized for canister piercing and fluid introduction according to this disclosure.

FIG. 2 is an exploded side view of an injection vessel fitting utilized for canister piercing according to this disclosure.

FIG. 3 is a side view of an injection vessel utilized for canister piercing and fluid introduction according to this disclosure.

FIG. 4 is an exploded side view of an injection vessel fitting utilized for canister piercing according to this disclosure.

FIG. 5 is a side view of an injection vessel utilized for canister piercing and fluid introduction according to this disclosure.

FIG. 6 is an exploded side view of an injection vessel fitting utilized for canister piercing according to this disclosure.

FIG. 7 is a side view of an injection vessel utilized for canister piercing and fluid introduction according to this disclosure.

FIG. 8 is an exploded side view of an injection vessel fitting utilized for canister piercing according to this disclosure.

FIG. 9 is an exploded perspective view of an embodiment of a discharge fitting of a fluid introduction device according to this disclosure.

FIG. 10 is a schematic diagram of the self-piercing action of the injection vessel to the fluid filled canister according to this disclosure.

FIG. 11 is a schematic diagram of an embodiment of an air condition system or refrigeration system according to this disclosure.

FIG. 12 is a schematic diagram of an embodiment of a self-piercing injection vessel coupled to a fluid filled canister and to an air conditioning system or refrigeration system according to this disclosure.

Like reference numerals are used throughout the Figures to denote similar elements and features. While aspects of this disclosure will be described in conjunction with the illustrated embodiments, this is not intended to limit this disclosure to such embodiments.

### DETAILED DESCRIPTION OF PREFERRED EMBODIMENTS

This disclosure is now described more fully with a reference to the set of accompanying illustrative drawings, in which example embodiments of this disclosure are shown. This disclosure may, however, be embodied in many different forms and should not be construed as necessarily being limited to the example embodiments disclosed herein. Rather, the example embodiments are provided so that this disclosure is thorough and complete, and fully conveys various concepts of this disclosure to those skilled in a relevant art.

Features described with respect to certain example embodiments may be combined and sub-combined in and/or with various other example embodiments. Also, different aspects and/or elements of example embodiments, as disclosed herein, may be combined and sub-combined in a similar manner as well. Further, some example embodiments, whether individually and/or collectively, may be components of a larger system, wherein other procedures may take precedence over and/or otherwise modify their application. Additionally, a number of steps may be required before, after, and/or concurrently with example embodiments, as disclosed herein. Note that any and/or all methods and/or processes, at least as disclosed herein, can be at least partially performed via at least one entity in any manner.

Various terminology used herein can imply direct or indirect, full or partial, temporary or permanent, action or inaction. For example, when an element is referred to as being “on,” “connected” or “coupled” to another element, then the element can be directly on, connected or coupled to the other element and/or intervening elements can be present, including indirect and/or direct variants. In contrast, when an element is referred to as being “directly connected” or “directly coupled” to another element, there are no intervening elements present.

Although the terms first, second, etc. can be used herein to describe various elements, components, regions, layers and/or sections, these elements, components, regions, layers and/or sections should not necessarily be limited by such terms. These terms are used to distinguish one element, component, region, layer or section from another element, component, region, layer or section. Thus, a first element, component, region, layer, or section discussed below could be termed a second element, component, region, layer, or section without departing from various teachings of this disclosure.

Various terminology used herein is for describing particular example embodiments and is not intended to be necessarily limiting of this disclosure. As used herein, various singular forms “a,” “an” and “the” are intended to include various plural forms as well, unless a context clearly indicates otherwise. Various terms “comprises,” “includes” and/or “comprising,” “including” when used in this specification, specify a presence of stated features, integers, steps, operations, elements, and/or components, but do not preclude the presence and/or addition of one or more other features, integers, steps, operations, elements, components, and/or groups thereof.

As used herein, a term “or” is intended to mean an inclusive “or” rather than an exclusive “or.” That is, unless specified otherwise, or clear from context, “X employs A or B” is intended to mean any of a set of natural inclusive permutations. That is, if X employs A; X employs B; or X employs both A and B, then “X employs A or B” is satisfied under any of the foregoing instances.

Example embodiments of this disclosure are described herein with a reference to illustrations of idealized embodiments (and intermediate structures) of this disclosure. As such, variations from various illustrated shapes as a result, for example, of manufacturing techniques and/or tolerances, are to be expected. Thus, various example embodiments of this disclosure should not be construed as necessarily limited to various particular shapes of regions illustrated herein, but are to include deviations in shapes that result, for example, from manufacturing.

Any and/or all elements, as disclosed herein, can be formed from a same, structurally continuous piece, such as being unitary, and/or be separately manufactured and/or connected, such as being an assembly and/or modules. Any and/or all elements, as disclosed herein, can be manufactured via any manufacturing processes, whether additive manufacturing, subtractive manufacturing, and/or other any other types of manufacturing. For example, some manufacturing processes include three dimensional (30) printing, laser cutting, computer numerical control routing, milling, pressing, stamping, vacuum forming, hydroforming, injection molding, lithography, and so forth.

Any and/or all elements, as disclosed herein, can be and/or include, whether partially and/or fully, a solid, including a metal, a mineral, an amorphous material, a ceramic, a glass ceramic, an organic solid, such as wood and/or a polymer, such as rubber, a composite material, a semiconductor, a nanomaterial, a biomaterial and/or any combinations thereof. Any and/or all elements, as disclosed herein, can be and/or include, whether partially and/or fully, a coating, including an informational coating, such as ink, an adhesive coating, a melt-adhesive coating, such as vacuum seal and/or heat seal, a release coating, such as tape liner, a low surface energy coating, an optical coating, such as for tint, color, hue, saturation, tone, shade, transparency, translucency, opaqueness, luminescence, reflection, phosphorescence, anti-reflection and/or holography, a photo-sensitive coating, an electronic and/or thermal property coating, such as for passivity, insulation, resistance or conduction, a magnetic coating, a water-resistant and/or waterproof coating, a scent coating and/or any combinations thereof. Any and/or all elements, as disclosed herein, can be rigid, flexible, and/or any other combinations thereof. Any and/or all elements, as disclosed herein, can be identical and/or different from each other in material, shape, size, color and/or any measurable dimension, such as length, width, height, depth, area, orientation, perimeter, volume, breadth, density, temperature, resistance, and so forth.

Unless otherwise defined, all terms (including technical and scientific terms) used herein have the same meaning as commonly understood by one of ordinary skill in an art to which this disclosure belongs. Various terms, such as those defined in commonly used dictionaries, should be interpreted as having a meaning that is consistent with a meaning in a context of a relevant art and should not be interpreted in an idealized and/or overly formal sense unless expressly so defined herein.

Furthermore, relative terms such as “below,” “lower,” “above,” and “upper” can be used herein to describe one element's relationship to another element as illustrated in the set of accompanying illustrative drawings. Such relative terms are intended to encompass different orientations of illustrated technologies in addition to an orientation depicted in the set of accompanying illustrative drawings. For example, if a device in the set of accompanying illustrative drawings were turned over, then various elements described as being on a “lower” side of other elements would then be oriented on “upper” sides of other elements. Similarly, if a device in one of illustrative figures were turned over, then various elements described as “below” or “beneath” other elements would then be oriented “above” other elements. Therefore, various example terms “below” and “lower” can encompass both an orientation of above and below.

As used herein, a term “about” and/or “substantially” refers to a +/−10% variation from a nominal value/term. Such variation is always included in any given value/term provided herein, whether or not such variation is specifically referred thereto.

If any disclosures are incorporated herein by reference and such disclosures conflict in part and/or in whole with this disclosure, then to an extent of a conflict, if any, and/or a broader disclosure, and/or broader definition of terms, this disclosure controls. If such disclosures conflict in part and/or in whole with one another, then to an extent of a conflict, if any, a later-dated disclosure controls.

In some embodiments, this disclosure enables a technology for managing a fluid, such as a liquid or a gas. For example, such management may include sending, receiving, inputting, outputting, containing, storing, or others. For example, the fluid may comprise a refrigerant. For example, this disclosure enables a technology for introducing a fluid into a refrigeration system, such as refrigerator, or an air conditioning system, such as a heating, ventilation, and air conditioning (HVAC) system. For example, a device may introduce a fluid, such as a refrigerant, whether in a liquid form or a gaseous form, into a refrigeration system or an air conditioning (AC/R) system. The AC/R system includes a first port, such as a service port, and a second port, such as a service port. The device includes an injection vessel, a first fitting, and a second fitting. The canister contains the fluid to be dispensed. The first fitting connects to the canister. The second fitting connects the canister to the service port. Resultantly, a path for the fluid is formed through the injection vessel from the canister to the service port in order to discharge the fluid from the canister and into the AC/R system. Note that although the AC/R system is described as a single system, the AC/R system may be a plurality of distinct systems, whether operating dependently or independently with respect to each other, whether in a single locale or a plurality of distinct locales, whether operated via a single operator or a plurality of distinct operators. Therefore, a refrigeration system and an air conditioning system may be distinct systems. This disclosure applies at least to both. For example, the refrigeration system may be a refrigerator, whether residential, commercial, scientific (biology/chemistry/physics), or others. For example, the air conditioning system may be residential, commercial, vehicle, whether land, air, or marine, or others.

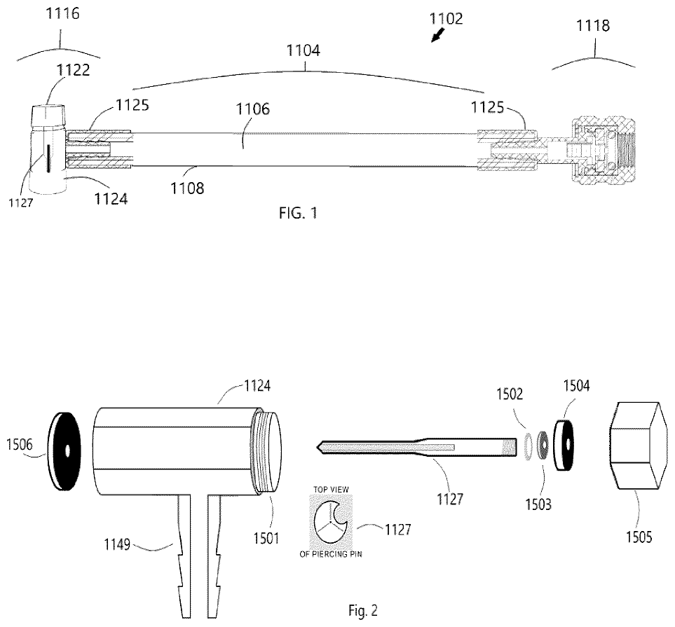

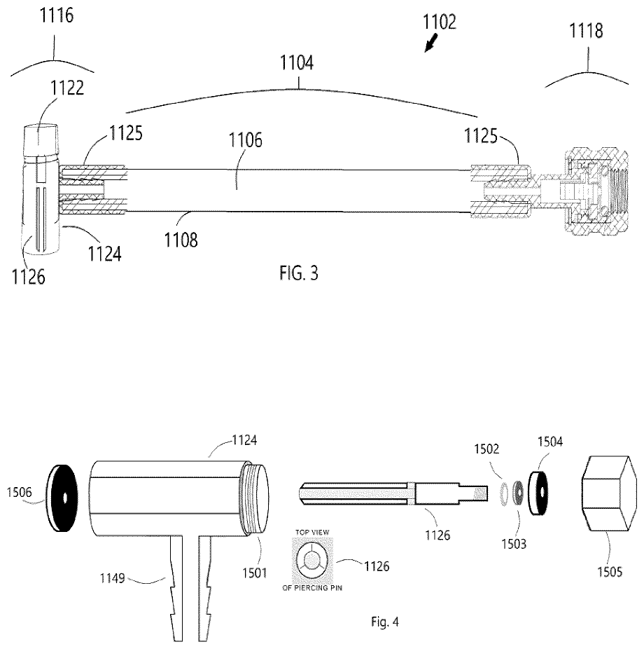

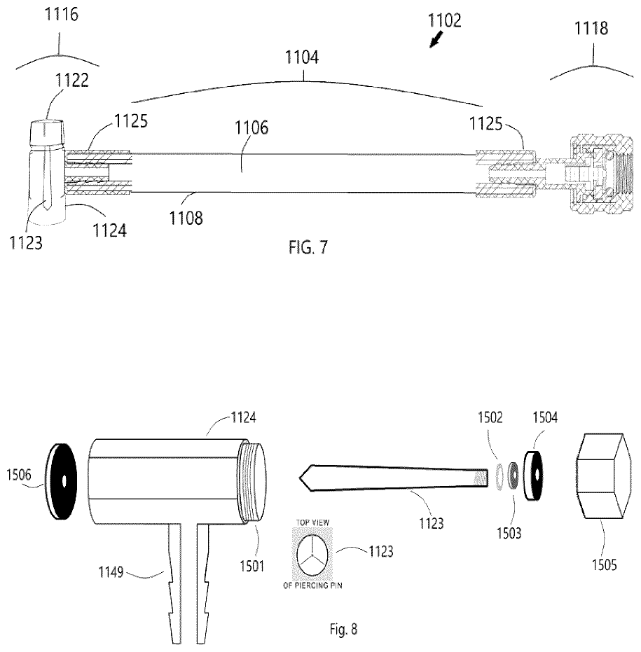

FIGS. 1, 3, 5, and 7 illustrate a device 1102 that may be used to self pierce a canister 1000 filled with a fluid 1106, such as a liquid or a gas, to facilitate injection of fluid. For example, the fluid 1106 may comprise a refrigerant or HVAC/R additive. The device 1102 may be used to introduce the fluid 1106 into an HVAC/R system.

As shown in FIG. 12, the fluid 1106 may be formulated for an introduction into an AC/R system 1301 through the low side service fitting or port 1308. The device 1102 may be used with the HVAC/R system 1301 that includes a compressor 1300 that is located between a high pressure side 1302 and a low pressure side 1304 in a refrigerant flow path, with the refrigerant being in a gaseous form on the low pressure side 1304 and in a liquid form on the high pressure side 1302 or a hot gas discharge port 1309. The AC/R system 1301 has a low side service fitting or port 1308 on the low pressure side 1304 and a high side service fitting or port 1306 and the hot gas discharge port 1309 on the high pressure side 1302. In some embodiments, each of the service ports 1306, 1308, and 1309 is a male fitting that is sealed by a normally closed valve, such as a Schrader style push valve, which may be spring biased into a normally closed position.

Referring again to FIGS. 1, 3, 5, and 7, the device 1102 includes a self piercing can tapper fitting 1116. The device 1102 pierces the canister 1000, FIG. 10 allowing the fluid 1106 entry through the device container 1104. The container 1104 may be a unitary piece of resilient flexible tubing 1108 that is formed from a transparent or translucent elastomer or a plastic or other polymer tubing reinforced with fiber braiding. In some embodiments, the tubing 1108 may not be reinforced with fiber braiding. In some embodiments, the tubing 1108 may be non-transparent or opaque rather than transparent, in whole or in part. In some embodiments, the container 1104 may be formed from or comprise a rigid material, such as copper, aluminum, an alloy, another other metal or a rigid polymer. In some embodiments, the container 1104 may be formed from or comprise a semi-rigid material, such as a malleable soft metal or a polymer.

The tube 1108 has a first end portion and a second end portion. The device 1102 includes a first fitting 1116 at one end of tubing 1108, such as at the first portion, and a second fitting 1118 at the other end of the tubing 1108, such as the second portion. As seen in FIG. 10, the fitting 1116 is configured for connecting one end of the container 1104 of device 1102 to a fluid filled canister 1000 such as mechanically or fluidly, and the second fitting 1118 is configured for connecting the other end of the container 1104 of device 1102 to the low side service port 1308 of the AC/R system 1301, such as mechanically or fluidly.

The fitting 1118 can be a low loss fitting configured to thread onto the service port 1308 or 1306. The fitting 1118 may include a normally closed valve mechanism that cooperates with the service port 1308 or 1306.

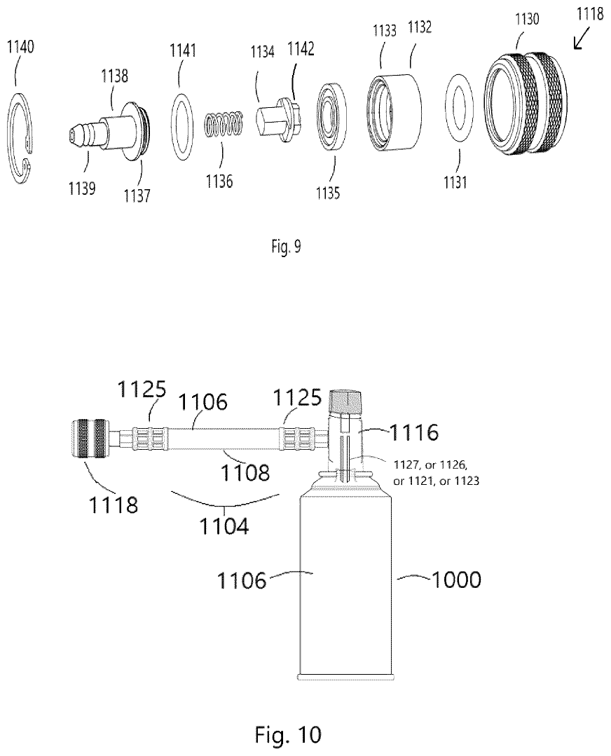

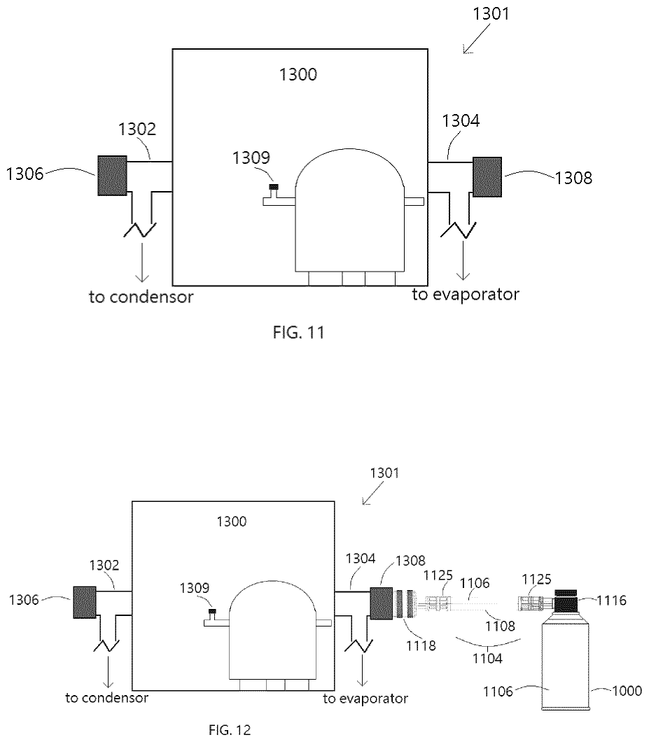

As shown in FIG. 9, the fitting 1118 can include an internally threaded valve housing 1130 for threading onto the service port 1308 or 1306, an O-ring 1131, an upper valve sleeve 1132 with a valve seat 1133, a gasket 1135, a depressor 1134, a spring 1136, an O-ring 1141, a lower valve sleeve 1138 with a threaded fitting 1137, a hose barb 1139, and a snap ring 1140. When the valve housing 1130 is screwed onto a service port, such as at least one of the service ports 1306, 1308, or 1309, the nub 1142 of the depressor 1134 interacts with a corresponding valve activator in the service port to displace the normally closed valve of the service port and the depressor 1134 from the gasket 1135 as defined by the upper valve sleeve 1132, and permit the fluid to flow through the fitting 1118. A height of the nub 1142 that is provided on an end of the depressor 1134 defines a size of a flow opening through the fitting 1118 and can be calibrated to provide a desired fluid flow rate in accordance with an application of the device 1102.

As shown in FIGS. 1, 3, 5, and 7, a crimp clamp 1125 is used to secure the fitting 1118 to the tubing 1108 by securing the hose barb 1139 of the valve sleeve 1138 to the container 1104. In some embodiments, the depressor 1134 interacts with the normally closed valve of the service port 1308 or 1306 such that securing the fitting 1118 to the service port 1308 or 1306 establishes a fluid communication between an interior of the container 1104 and the low side 1304 or high side 1302 of the compressor 1300 shown in FIG. 12.

The fitting 1116 can contain multiple styles of piercing pin, as seen in FIGS. 1, 3, 5, and 7; wherein the piercing pin has a channel cutaway or passage 1127, a hollow pin or tube 1126, a spearhead 1121, or a tapered pin 1123 within the housing 1124 which is configured to thread onto a fluid filled canister 1000 in FIG. 10.

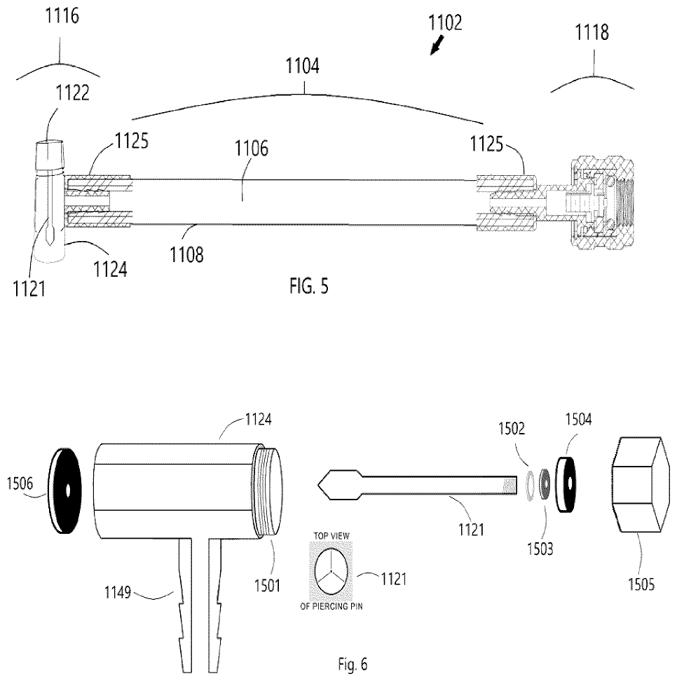

As shown in FIGS. 2, 4, 6, and 8, the fitting 1116 can include an internal gasket 1506, a valve housing 1124 with threads 1501, a hose barb 1149, piercing pin options 1127, 1126, 1121, and 1123, a washer 1502, an 0-ring 1503, a gasket 1504, and an internally threaded nut end cap 1505. Combined, these components comprise the self piercing fitting 1116.

In some embodiments the fitting 1116 of device 1102 can be secured to the canister 1000, such as by threading or coupling, as seen in FIG. 10. As the fitting 1116 is secured to the canister 1000, the piercing pin(s) 1127, 1126, 1121, and 1123 pierce through the normally closed seal of the canister 1000. The internal gasket 1506 prevents loss of vacuum and/or pressure and/or fluid during piercing action. This allows flow of fluid 1106 from the canister 1000 into the device of 1102, FIG. 10.

As shown in FIG. 9, the fitting 1118 comprises a low loss fitting that is normally closed until manually opened. As fitting 1118 of device 1102 is coupled to a service port 1308 or 1306 of AC/R system 1301, this causes a normally closed valve of the low loss fitting 1118 and a normally closed valve of the service port 1308 or 1306 to be moved into an open state.

As shown in FIGS. 1, 3, 5, and 7 the crimp clamp 1125 is used to secure the fitting 1116 to the tubing 1108 by securing the hose barb 1149 of the valve sleeve 1124 to the container 1104.

In a first step, a user secures the self piercing fitting 1116 of the device 1102 to the canister 1000, which causes a normally closed sealed canister 1000 to be pierced creating an open state, thereby establishing a fluid communication between an interior of the canister 1000 and the device 1102.

In a second step, a user secures the low loss fitting 1118 of device 1102 to the low side service port 1308 of the AC/R system 1301, while the system is turned off, as seen in FIG. 12. In some embodiments, such a feature may effectively minimize or mitigate against an accidental escape of refrigerant onto a hand or a body part of a user during a coupling process. This causes the normally closed fitting 1118 to interact with the normally closed service port 1308 to create and open state, thereby establishing a fluid communication between an interior of the device 1102 and the AC/R system 1301. The pressure differential between the static AC/R system 1301 and device 1102 secured to canister 1000 allows the refrigerant fluid from AC/R system 1301 to enter the interior of the container 1104 through the fitting 1118, through fitting 1116 and into the interior of the canister 1000. This action adds pressure to the canister 1000 equal to the static pressure of the AC/R system 1301. In some embodiments, the low loss fitting 1118 may be secured to a refrigerant cylinder for pressurizing and then secured to the low loss service port 1308 of the AC/R system 1301 after pressurized.

In a third step, the AC/R system 1301 is turned on which causes a notable decrease in pressure of the AC/R system 1301 at the low side service port 1308. Utilizing the created pressure differential between the canister 1000 and the low side service port 1308, the fluid 1106 is able to flow from the canister 1000 through the device 1102 into the AC/R system 1301 through the low side service port 1308. In some embodiments, the container 1104 is transparent or translucent so that a user can see when the fluid 1106 is fully discharged. In some embodiments, an assumption is made that a full discharge has occurred after a predetermined duration.

In a final step, once discharge of the fluid 1106 is complete, a user removes the low loss fitting 1118 from the low side service port 1308, which causes the low loss fitting 1118 and the low side service port 1308 to normally close.

An amount of the fluid 1106 and a discharge rate of the fluid 1106 from the container 1104, as disclosed herein, can be controlled by a number of factors, including (1) a volume and a dimension, such as a length or an internal diameter of the tubing 1108 or canister 1000, (2) a volume and a dimension, such as length or an internal diameter, of the fluid gas passage located in the piercing pin can be altered in size to increase or decrease flow, (3) a size of the valve openings included in the fittings 1116, and 1118 when in an open state, (4) a characteristic of the fluid 1106, such as a viscosity, or (5) a pressure of the service port 1308. For example, at least one of such factors can be calibrated according to a use of the device 1102, at least as disclosed herein, such that a design of the device 1102 can be adapted to accommodate a wide range of fluids, air conditioning systems, or refrigeration systems.

In some embodiments, various devices of FIGS. 1, 3, 5 and 7 can be used to facilitate an introduction of the fluid including the use of ambient air.

In some embodiments, where the fluid 1106 is colored, a departure of the fluid 1106 is easily observed. In some embodiments, where the tubing 1108, which may be flexible, is used as all or part of the container 1104, a device, as disclosed herein, can be configured or manipulated for a use in a tight area or to connect to different AC/R configurations.

The low loss fitting 1118 can take a number of different configurations. In some embodiments, the low loss fitting 1118 comprises a ¼″ SAE low loss fitting. In some embodiments, the low loss fitting 1118 comprises a 5/16″ SAE low loss fitting. In some embodiments, the low loss fitting 1118 comprises a 1134A ½″ ACME automotive fitting, or any other suitable automotive A/C fitting. In some embodiments, the low loss fitting 1118 comprises a quick lock and release fitting.

The fluid 1106 could be selected from any number of possible fluids, such as liquids or gases, that are required or useful for maintenance of air conditioning or refrigerant systems. In some embodiments, the fluid 1106 could include an oil, a sealant (including a refrigerant sealant), a leak detection dye (including a fluorescent dye), a refrigerant gas, a performance enhancing fluids, or others. In some embodiments, the fluid 1106 includes a lubricant or a lubricant additive. For example, the lubricant may comprise a refrigeration lubricant. For example, the lubricant additive may comprise an organosilane, an orthoester, an antioxidant, or an anticorrosion additive. For example, a suitable orthoester that may be included in the fluid 1106 as the lubricant additive could comprise a triethylorthoformate. In some embodiments, an organosilane component comprises about 0% to about 20% by weight of the fluid 1106. In some embodiments, the orthoester component or components comprises from about 0% to about 100% by weight of a total amount in any fluid management device disclosed herein.

In some embodiments, the fluid 1106 includes a colorant that allows the fluid 1106 to be easily seen through the tubing 1108, which may be transparent, to allow an easy visual confirmation of a presence of or an amount of the fluid 1106 present in the tubing 1108. For example, such colorant is not a florescent dye, such as used to allow leaks to be detected in a refrigerant system, although in some applications a fluorescent dye may be used, such as an ultraviolet (UV) dye could also be included in the fluid 1106. A suitable non-dye colorant may comprise Chromatint Blue HF or others.

At least some of the additives noted above may function as a drying agent to reduce a moisture level of the lubricant that is included in the fluid 1106. Such use, in some applications, can increase a storage life of the fluid 1106 by mitigating against a breakdown of a chemical component of the fluid 1106.

In some embodiments, the lubricant in the fluid 1106 can function to stop a fluid leak in an air-conditioning system or a refrigeration system that the fluid 1106 is injected into.

In some embodiments, a number of different compositions are possible for the fluid 1106. One possible composition consists of a polyolester lubricant, a triethyl orthoformate, a Vinyltrimethoxysilane, a N-(3-(trimethoxysilyl)propyl)ethylenediamine, methyltrimethoxysilane, a tint solution, or others.

In some embodiments, the fluid 1106 can include a small or a micron size particle, such as a Teflon particle or others.

In some embodiments, all or a part of the container 1104 is formed from a rigid component.

In some embodiments, various functions or acts can take place at a given location and/or in connection with the operation of one or more apparatuses or systems. In some embodiments, a portion of a given function or act can be performed at a first device or location, and a remainder of the function or act can be performed at one or more additional devices or locations.

The corresponding structures, materials, acts, and equivalents of all means or step plus function elements in the claims below are intended to include any structure, material, or act for performing the function in combination with other claimed elements as specifically claimed. The embodiments were chosen and described in order to best explain the principles of the disclosure and the practical application, and to enable others of ordinary skill in the art to understand the disclosure for various embodiments with various modifications as are suited to the particular use contemplated.

The diagrams depicted herein are illustrative. There can be many variations to the diagram or the steps, or operations described therein without departing from the spirit of the disclosure. For instance, the steps can be performed in a differing order or steps can be added, deleted or modified. All of these variations are considered a part of the disclosure. It will be understood that those skilled in the art, both now and in the future, can make various improvements and enhancements which fall within the scope of the claims which follow.

The description of this disclosure has been presented for purposes of illustration and description, but is not intended to be fully exhaustive and/or limited to the disclosure in the form disclosed. Many modifications and variations in techniques and structures will be apparent to those of ordinary skill in an art without departing from a scope and spirit of this disclosure as set forth in the claims that follow. Accordingly, such modifications and variations are contemplated as being a part of this disclosure. A scope of this disclosure is defined by various claims, which include known equivalents and unforeseeable equivalents at a time of filing of this disclosure.

1. A device comprising:
a container including a first end portion and a second end portion;
a first fitting including a stationary pin, wherein the first end portion hosts the first fitting; and
a second fitting including a valve that is closed by default, wherein the second end portion hosts the second fitting, wherein the stationary pin is configured to pierce a canister storing a fluid responsive to the first fitting being secured to the canister and the valve is configured to open responsive to the second fitting being secured to a service port of a system such that the fluid is able to travel from the canister to the service port through the first fitting, the container, and the second fitting, wherein the system includes at least one of an air conditioning system or a refrigeration system.

2. The device of claim 1, wherein the stationary pin is a pin with a linear channel cutaway or passage.

3. The device of claim 1, wherein the stationary pin is a hollow pin or tube.

4. The device of claim 1, wherein the stationary pin is a tapered spearhead pin.

5. The device of claim 1, wherein the stationary pin is a straight tapered pin.

6. The device of claim 1, wherein the fluid is able to travel from the canister to the low side service port through the first fitting, the container, and the second fitting when the system is running.

7. The device of claim 1, wherein the fluid is able to travel from the canister to the low side service port through the first fitting, the container, and the second fitting when the system is not running.

8. The device of claim 1, wherein the fluid is an additive.

9. The device of claim 1, wherein the fluid is a refrigerant.

10. The device of claim 1, wherein the fluid is an oil.

11. The device of claim 1, wherein the fluid is a sealant.

12. The device of claim 1, wherein the fluid is a leak detection dye.

13. The device of claim 1, wherein the fluid is a lubricant.

14. The device of claim 1, wherein the fluid is a lubricant additive.

15. The device of claim 1, wherein the fluid is a colorant.

16. The device of claim 1, wherein the fluid is a UV dye that is visible under a UV light.

17. The device of claim 1, wherein the fluid is a colorant or dye that is visible under a natural light.

18. The device of claim 1, wherein the fluid is an oil additive.

19. The device of claim 1, wherein the fluid is a refrigerant sealant.

20. The device of claim 1, wherein the fluid is a suspension including a micron sized particle.

21. The device of claim 1, wherein the service port is a low side service port.

22. The device of claim 1, wherein the system is an air conditioning system.

23. The device of claim 1, wherein the system is a refrigeration system.

24. The device of claim 1, wherein the service port is closed by default and opened responsive to the second fitting being secured to the service port such that the fluid is able to travel from the canister to the service port through the first fitting, the container, and the second fitting.

25. The device of claim 24, wherein the service port is a male fitting.

26. The device of claim 1, wherein the fluid is colored for visibility under a natural light, wherein the container includes a portion that is not opaque such that the fluid is visible under the natural light through the portion when the fluid travels along the portion.

27. The device of claim 1, wherein the first fitting includes a hose barb, wherein the first end portion hosts the first fitting via the hose barb, wherein the stationary pin is not parallel to the hose barb.

28. The device of claim 27, wherein the first end portion hosts the first fitting via a clamp extending about the hose barb external to the container.

29. The device of claim 1, wherein the first fitting includes a housing that houses the stationary pin, wherein the first fitting is configured to being secured to the canister via the housing fastening to the canister such that the stationary pin pierces the canister.

30. The device of claim 29, wherein the first fitting includes an end cap, wherein the stationary pin is coupled to the end cap, wherein the end cap is coupled to the housing such that the stationary pin extends within the housing, wherein the housing houses a first gasket, a washer, a ring, and a second gasket, wherein the washer and the ring are positioned between the first gasket and the second gasket.

31. A method comprising:
causing a stationary pin to pierce a canister storing a fluid responsive to a first fitting being secured to the canister, wherein the first fitting includes the stationary pin, wherein the first fitting is secured to a first end portion of a container, wherein the container includes a second end portion hosting a second fitting, wherein the second fitting includes a valve that is closed by default; and
causing the valve to open responsive to the second fitting being secured to a service port of a system such that the fluid is able to travel from the canister to the service port through the first fitting, the container, and the second fitting.
